(19) United States
(12) Patent Application Publication
(10) Pub. No.: US 2017/0360643 A1
(43) Pub. Date: Dec. 21, 2017

(54) METHOD AND APPARATUS FOR RELIEVING PHYSICAL DISCOMFORT

(71) Applicant: Jay KORROL, West Palm Beach, FL (US)

(72) Inventor: Jay KORROL, West Palm Beach, FL (US)

(21) Appl. No.: 15/494,494

(22) Filed: Apr. 22, 2017

Related U.S. Application Data
(63) Continuation-in-part of application No. 29/562,992, filed on Apr. 30, 2016.
(60) Provisional application No. 62/330,138, filed on Apr. 30, 2016.

(51) Int. Cl. A61H 1/00

(52) U.S. Cl. CPC A61H 1/008; A61H 2205/106; A61H 2201/1642; A61H 2201/1645; A61H 2201/165

(57) ABSTRACT

A pressure applicating assembly for treatment of menstrual cramps and other discomfort; the apparatus comprising a pressure applicator apparatus and a flexible strap. The pressure applicator apparatus comprises a plurality of styluses arranged in both a direction parallel to the strap and a direction perpendicular to the strap. The pressure applicator apparatus is secured to a patient using the strap in a manner to apply pressure to a tender location on an interior region of a patient's calf. The applied pressure can be employed to relieve the patient of menstrual discomfort by identifying the tender spot by applying light pressure to a menstrual discomfort controlling pressure region. The identified tender spots are considered the menstrual discomfort controlling pressure points. The plurality of styluses applies a distributed pressure to the region to ensure the tender spots are sufficiently addressed, thus relieving the patient of the discomfort.

### CROSS REFERENCE TO RELATED APPLICATIONS

This Non-Provisional Patent Application claims the benefit of:
A) U.S. Provisional Patent Application Ser. No. 62/330,138, filed on Apr. 30, 2016, and
B) U.S. Design patent application Ser. No. 29/562,992, filed on Apr. 30, 2016, and

both of which are incorporated herein by reference in their entireties.

### FIELD OF THE INVENTION

This invention relates to the field of physical discomfort management by application of pressure to a respective pain management region of one's body.

### BACKGROUND OF THE INVENTION

Acupuncture has long been an accepted method of treatment in Oriental medicine guided by the principles that the body has meridians in which Qi (energy) flows. Each meridian represents a different organ and each organ represents different aspects and functions. Each meridian has its own set of points and these points also represent different aspects and functions within that meridian's organ. There are certain points in all meridians that have specific functions in common.

By inserting needles at various points in the body along the meridians, the flow of internal energy is redirected bringing relief to the sufferers of various maladies. There are many texts on the subject which teach the location of acupuncture points in the body along with which point is beneficial for treatment of certain symptoms. By inserting the needles at specific points, a particular malady or its symptoms can be successfully treated. There has been a lack of general acceptance of acupuncture resulting from skepticism regarding the theory and reluctance to undergo the needle punctures with the attendant possibility of localized pain and infection.

It has now been determined that acupressure which teaches merely applying external pressure to the acupuncture points on the body can have the same or similar results without the need of needle punctures. Such treatment clearly overcomes a patient's fear of needle sticks and infection.

The skilled practitioner of acupuncture/acupressure is trained in the diagnosis required by this 3,000-5,000 year old art and the selection of the treatment site on the patient's body that will produce beneficial effects for the diagnosed malady. There are a great many acupoints on the body, the location of each usually described in anatomical terms. The art in the practice is the selection of the proper acupoint or acupoints to use when a malady involves more than one organ and meridian. The skilled artisan can precisely locate these points to bring the full effect of the treatment to bear accurately and squarely on the selected point. The patient's relief may be immediate. In syndromes with recurring cycles, such as problems associated with menstruation, repeated acupressure treatment may be required at the onset of each episode of symptoms.

One of the sets of points in all meridians is known as, “Accumulation Points.” Each meridian has one. The main function of these points is for, “acute,” (sudden onset) patterns accompanied by pain. The particular point of interest here is the accumulation point along the Spleen meridian, specifically the 8th (Sp 8) of the 21 points that belong to the Spleen meridian.

There have been attempts to bring the benefits of acupressure to the public through self-help publications and apparatus to be applied to various parts of the body.

### DESCRIPTION OF THE PRIOR ART

In one known solution, a wrist band which applies an electric current to the body to treat menstrual cramps.

In a second known solution, an undergarment brief with a pressure insert mounted on an elastic panel for applying pressure to the abdominal area to relieve menstrual cramps.

In another known solution, an elastic band with dense hook and loop fasteners carrying a flexible protuberance to be applied about different parts of the body, as the consumer sees fit, so that the protuberance contacts an acupoint. To use the device, the consumer would have to be skilled in the Chinese diagnoses of a malady, make the correct diagnoses, and correctly select one acupoint to treat the diagnosed malady.

In yet another known solution, the use of an elastic belt with adjustable acupressure pads, in addition to heat pads, for placement about the waist of a user. The belt may have dense hook and loop fasteners for connecting the ends together.

In yet another known solution, the use of an adhesive pad supporting a rigid nub for applying pressure to a selected point on the body.

In another known application, issued to the Inventor, the process of relieving menstrual cramp discomfort is accomplished by applying pressure to an area using one or two pressure applicator points. This requires specific placement of the pressure applicator to the precise area on the patient's body.

What the prior art lacks is a teaching of a specific apparatus to be applied to a specific location to treat a specific malady accompanied with the clear instructions of how and where the consumer is to apply the apparatus.

### SUMMARY OF THE INVENTION

Accordingly, it is a primary objective of the instant invention to teach the construction of a pressure applicating apparatus carrying a stylus or plurality of styluses for applying pressure to a menstrual discomfort controlling pressure point on a body of a patient, the pressure applicating device comprising at least three styluses arranged in a non-parallel arrangement; the pressure applicating device being carried by an attachment strap employed for securing the pressure applicating device to the patient.

In a second aspect of the present invention, the pressure applicating device comprising a first set of styluses arranged linearly to one another and at least one other stylus located non-linear to the first set of styluses.

In another aspect of the present invention, the pressure applicating device comprising a first set of styluses arranged linearly to one another and parallel to a longitudinal direction of the attachment strap and at least one other stylus located non-linear to the first set of styluses.

In yet another aspect of the present invention, the pressure applicating device comprising a first set of styluses arranged linearly to one another and parallel to a longitudinal direction of the attachment strap and at least one other stylus located non-linear to the first set of styluses.

In yet another aspect of the present invention the pressure applicating device comprising a first set of styluses arranged parallel to a direction parallel to the attachment strap and a second set of styluses arranged perpendicular to the direction parallel to the attachment strap.

In yet another aspect of the present invention, the pressure applicating device comprising a first set of styluses arranged linearly to one another and parallel to a longitudinal direction of the attachment strap and a second set of styluses arranged linearly to one another and perpendicular to the direction parallel to the attachment strap.

In yet another aspect of the present invention, each stylus extends outward from a stylus base portion.

In yet another aspect of the present invention, each stylus extends substantially perpendicularly outward from a stylus base portion.

In yet another aspect, the use of a kit containing a pressure applicating band with detailed instructions informing the consumer to correctly place and apply the band.

In yet another aspect, the construction of a pressure applicating band wherein the plurality of styluses are located and arranged for maximum sustained pressure.

In yet another aspect, each stylus comprising a contacting surface of each stylus located at a free end of a riser portion of the stylus.

In yet another aspect, a portion of the styluses further comprise a stylus broad base feature, the broad base feature having a stylus peripheral relief ridge extending radially from a base end of the riser portion of the stylus, the stylus peripheral relief ridge extending across a free end of the stylus base feature.

In yet another aspect, the stylus broad base feature further comprising a stylus peripheral relief ring, wherein the stylus peripheral relief ridge extending circumferentially about a peripheral edge of the stylus peripheral relief ring. The stylus peripheral relief ridge can be raised slightly above a plane defined by the stylus peripheral relief ring.

In yet another aspect, the stylus base feature further comprises a tapered upper section.

In yet another aspect, the stylus base feature further comprising a frustum shaped upper section.

In yet another aspect, the stylus riser is formed having at least a portion thereof having a tapered shape.

In yet another aspect, the stylus riser is formed having at least a portion thereof having a frustum shape. The stylus riser would include a taper from a base end towards a smaller distal or free end.

In yet another aspect, the broad based stylus providing an omni-directional pivotal motion of the stylus riser respective to the broad base feature.

In yet another aspect, the stylus peripheral relief ring is formed having a thickness sufficiently flexible to enable the omni-directional pivotal motion of the stylus riser respective to the broad base feature.

In yet another aspect, each stylus further comprises a transition between the riser and the contacting surface, the transition having a radius.

In yet another aspect, each stylus further comprises a transition between the riser and the contacting surface, the transition having a chamfer.

In yet another aspect, the contacting surface of each stylus is arranged being generally perpendicular to an elongated axis of the riser portion of the stylus.

In yet another aspect, the pressure applicating band comprising styluses having at least two different heights.

In yet another aspect, the pressure applicating band comprising styluses having pressure applicating surfaces located at different planes. The planes are generally parallel to one another and parallel to the base section.

In yet another aspect, the pressure applicating band comprising one set of styluses having pressure applicating surfaces located at a first plane and a second set of styluses having pressure applicating surfaces located at a second plane.

In yet another aspect, the pressure applicating band further comprising a second set of styluses, each of the second set of styluses being located in a distal corner of an arrangement formed by the first set of styluses.

In yet another aspect, each contacting surface of the second set of styluses is located at a plane that differs from the plane defined by the contacting surfaces of the first set of styluses.

In yet another aspect, each contacting surface of the first set of styluses is circular in shape.

In yet another aspect, each contacting surface of the second set of styluses is elongated in shape. For example, the contacting surface has a rounded rectangular shape.

In yet another aspect, the pressure applicating band further comprising a third set of styluses, each of the third set of styluses being located in linear arrange with a portion of the first set of styluses along an axis perpendicular to an elongated axis of the strap.

In yet another aspect, each contacting surface of the third, supplemental set of styluses is circular in shape.

In yet another aspect, the base member further comprising a pair of slots, each slot located at opposite sides of the base member, each slot being arranged to receive the strap.

In yet another aspect, the strap comprises a buckle, the buckle being attached to the strap at one end thereof. In one variant, the buckle is fabricated having a rectangular shape defining a strap receiving aperture passing therethrough. The strap is attached to the buckle by forming a loop in the strap, the loop circumscribing one side of the buckle.

In yet another aspect, the strap being fabricated of a dense hook and loop material.

In yet another aspect, the strap having a length suitable for circumscribing a patient's leg, more specifically a calf region of a person's leg.

In yet another aspect, the dense hook and loop material provides an attachment feature providing adjustability to a length of the strap when secured about an appendage of an individual.

In yet another aspect, the pressure applicating apparatus comprising an outer element formed having the base member and the plurality of styluses and a core member formed having support structure for at least a portion of the styluses of the plurality of styluses. The core member comprising a core member frame, the core member frame supporting each stylus supporting feature. Each stylus supporting feature can include a stylus supporting member distal end located at an end of a stylus supporting riser, the stylus supporting riser being supported by a stylus supporting base element. Each stylus supporting feature being sized and positioned to engage with an interior of a respective stylus.

The present invention introduces a method of locating a menstrual discomfort controlling pressure region. The patient or subject identifies a tender location on the inner, rear calf on either leg and continuously applies a pressure to the general area until the discomfort diminishes.

In yet another aspect, a plurality of pressure styluses is utilized to apply a pressure about a region proximate the menstrual discomfort controlling pressure region (tender region).

In yet another aspect, a plurality of pressure styluses provided in a non-linear arrangement is utilized to apply a pressure about a region proximate the menstrual discomfort controlling pressure region (tender region).

In yet another aspect, the menstrual discomfort controlling pressure region (tender region) is located between SP7 (Longu) and SP 8 (Diji) on an inside portion of a calf of a patient. This region has a span or distance therebetween of approximately 4 inches (4″).

In yet another aspect, a plurality of pressure styluses are provided wherein at least a portion of the plurality of pressure styluses having contacting surfaces defining a first plane and a second portion of the plurality of pressure styluses having contacting surfaces defining a second plane, the first plane being different than the second plane. The planes are substantially parallel with one another and substantially parallel to a plane of the pressure applicator base member stylus supporting surface. The two levels provide differing degrees of pressure to the patient.

In yet another aspect, the process is adapted for addressing discomfort associated with endometriosis. In this application, the pressure application apparatus is located on a patient's leg extending between SP9 (Yinlingquan) and SP6 (SanyinJiao). The application can utilize a plurality of pressure application apparatuses or an elongated single pressure application apparatus comprising additional styluses.

In another method the patient or subject identifies a tender location on the inner, rear calf on either leg and applying stimulating pulses across the surface of the skin and along the nerve strands using a Transcutaneous Electrical Nerve Stimulation (TENS) system to the general area until the discomfort diminishes.

In a second aspect of the method, the user locates at least one electrode to the tender location on the patient.

In another aspect of the method, the user locates a pair of electrodes to an elongated region associated with the tender location on the patient.

In another aspect of the method, the user locates a plurality of electrodes to an elongated region associated with the tender location on the patient.

In another aspect of the method, the user adjusts an amplitude and/or frequencies of a waveform provided to the electrodes.

In another aspect, the electrodes can be provided in any shape.

In another aspect, the electrodes can be provided in a round shape, an oval shape, an elliptical shape, a square shape, a rectangular shape, a triangular shape, a quadrilateral shape, a pentagonal shape, a hexagonal shape, an octagonal shape, and the like. The electrodes can be provided in any other suitable shape.

In another aspect, the TENS unit controller can include an analog adjustment mechanism to adjusts an amplitude and/or frequencies of a waveform provided to the electrodes.

In another aspect, the TENS unit controller can include a digital adjustment controller to adjusts an amplitude and/or frequencies of a waveform provided to the electrodes.

Other aspects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE DRAWINGS

The invention will now be described, by way of example, with reference to the accompanying drawings, where like numerals denote like elements and in which:

FIG. 1 presents an isometric view of an exemplary pressure applicating apparatus, including an attachment strap;

FIG. 2 presents an isometric exploded assembly view of the pressure applicating apparatus, introducing a pressure applicating shell and a pressure applicating core member;

FIG. 3 presents an isometric view of an exemplary stylus, the illustration detailing the features thereof;

FIG. 4 presents a side elevation view of a patient's leg, the illustration introducing a general region for locating a menstrual discomfort controlling pressure region;

FIG. 5 presents a side elevation view of the pressure applicating assembly being secured to the patient's leg in the menstrual discomfort controlling pressure region to relieve the patient from menstrual discomfort;

FIG. 6 presents a side elevation view of the pressure applicating assembly secured to the patient's leg in the menstrual discomfort controlling pressure region to relieve the patient from menstrual discomfort;

FIG. 7 is an exemplary flow diagram describing steps for relieving menstrual discomfort;

FIG. 8 presents a side elevation view of a patient's leg, the illustration introducing an adaptation of the process for controlling discomfort associated with Endometriosis; and

FIG. 9 presents a side elevation view employing a Transcutaneous Electrical Nerve Stimulation (TENS) system having at least one electrode of the TENS system adhered to the patient's leg in the menstrual discomfort controlling pressure region to relieve the patient from menstrual discomfort.

Like reference numerals refer to like parts throughout the various views of the drawings.

### DETAILED DESCRIPTION OF THE INVENTION

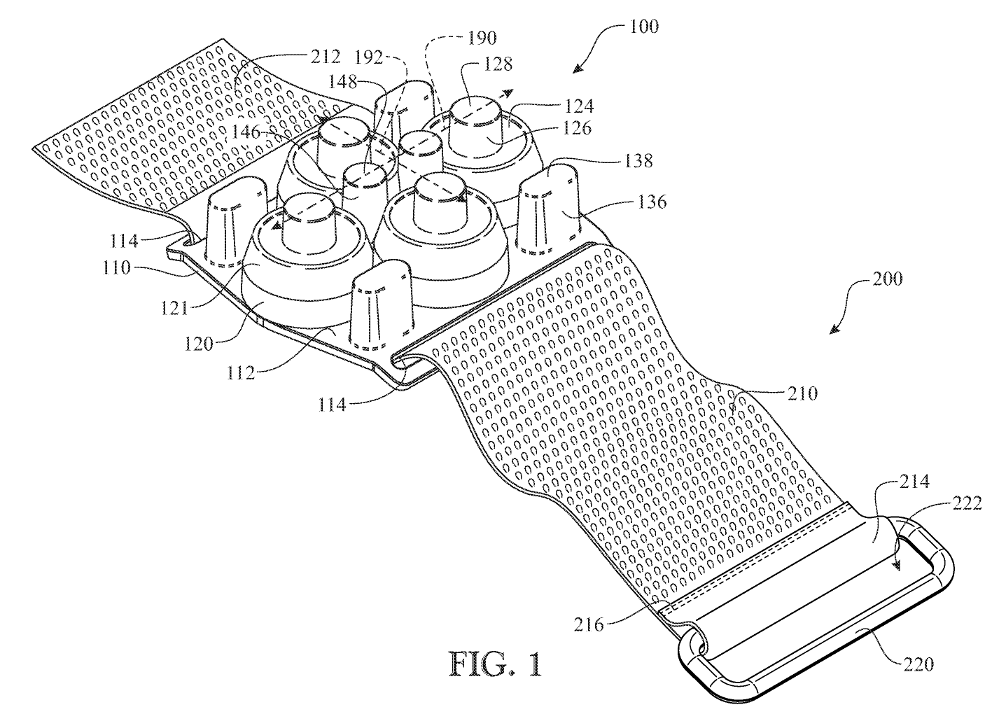

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

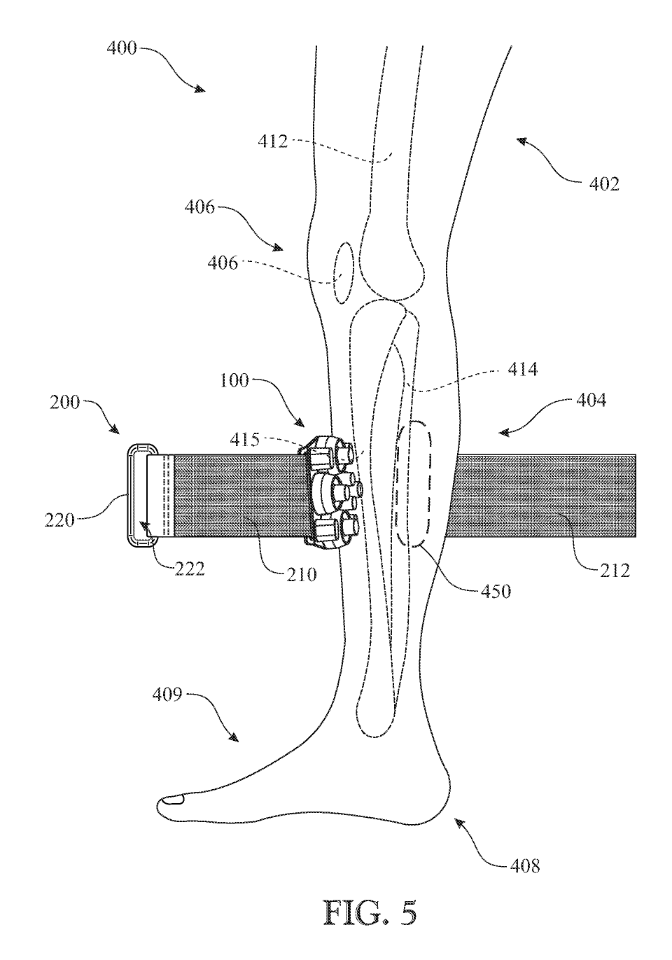

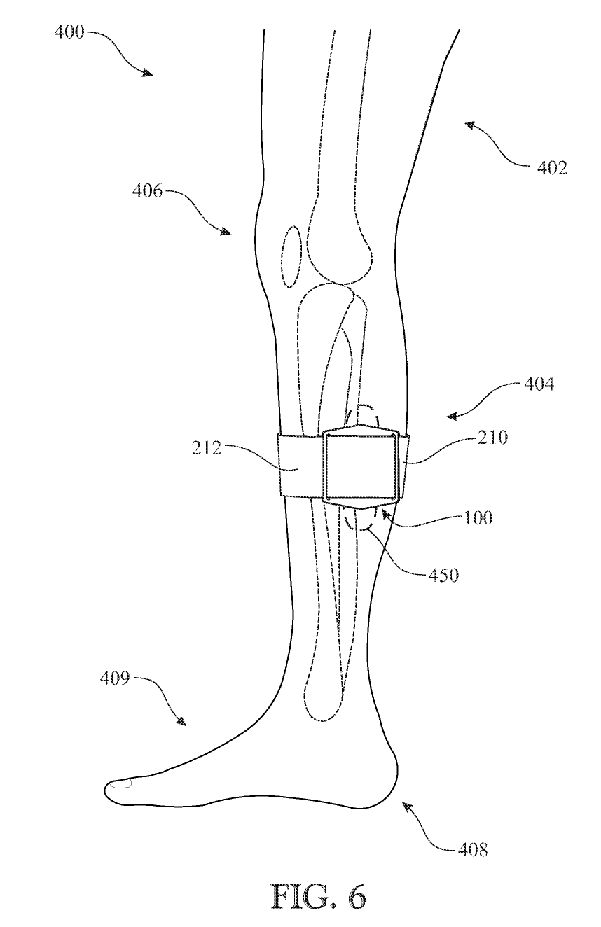

A pressure applicator apparatus 100, illustrated in FIGS. 1 through 4, can be used to apply pressure to a patient's body to relieve discomfort from one or more ailments. A pressure applicator apparatus attachment strap assembly 200 is assembled to the pressure applicator apparatus 100, wherein the pressure applicator apparatus attachment strap assembly 200 is employed to secure the pressure applicator apparatus 100 on the patient in a desired location, as shown in FIGS. 5, 6 and 8. The placement shown in FIGS. 5 and 6 demonstrates an application to relieve menstrual discomfort.

The pressure applicator apparatus 100 is fabricated comprising a pressure applicator base member 110, wherein the pressure applicator base member 110 supports a series of styluses, as described below. The pressure applicator base member 110 can be planar in shape or include a slightly curved shape to accommodate the pressure applicator apparatus attachment strap assembly 200. A pair of strap receiving slots 114 is formed through the pressure applicator base member 110. Each strap receiving slot 114 is located proximate a respective edge of the pressure applicator base member 110. The pressure applicator base member 110 can be formed bending downward or away from the stylus at and outward of each strap receiving slot 114. This formation ensures against interference between the pressure applicator apparatus attachment strap assembly 200 and operation of the pressure applicator apparatus 100. The pressure applicating apparatus 100 is fabricated of a tough elastic polymeric substance or a material having rubbery properties. Examples of a tough elastic polymeric substance include rubber, nylon, silicon, an elastomer, and the like.

The pressure applicator apparatus attachment strap assembly 200 includes a strap buckle 220 affixed to a pressure applicator apparatus attachment strap coupling end 210 of the pressure applicator apparatus attachment strap assembly 200 by a strap buckle assembly loop 214. The pressure applicator apparatus attachment strap assembly 200 can be formed of a solid plastic ribbon, a woven fabric or textile, a non-woven material, a silicone, a rubber, and the like, wherein the selected material is flexible enough to be coiled on itself. The material can be of a non-elastic or an elastic material.

The respective portion of the pressure applicator apparatus attachment strap coupling end 210 is looped about one elongated segment of the strap buckle 220 and joined to the pressure applicator apparatus attachment strap coupling end 210 by a strap buckle assembly loop seam 216. The strap buckle 220 includes a strap buckle aperture 222 passing therethrough for receiving a portion of a pressure applicator apparatus attachment strap free end 212 of the pressure applicator apparatus attachment strap assembly 200. The free end of the pressure applicator apparatus attachment strap assembly 200 is threaded through each strap receiving slot 114 as illustrated in FIG. 1, to prepare the pressure applicator apparatus 100 for use. In an alternative arrangement, the strap buckle 220 can be integrated into the pressure applicator apparatus attachment strap assembly 200.

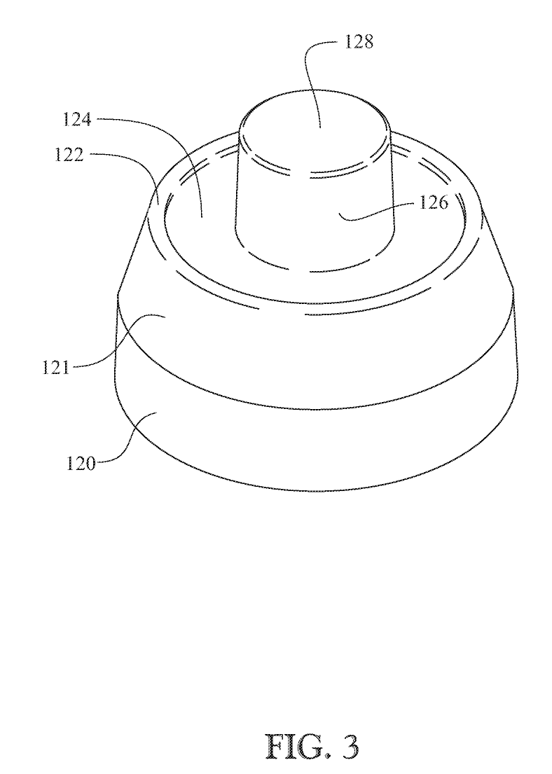

The pressure applicator apparatus 100 includes a first or primary set of styluses. The primary stylus is detailed in the illustration shown in FIG. 3. Each primary stylus comprising a primary stylus riser 126 having a primary stylus pressure applying contacting surface 128 located at a distal free end thereof. The primary stylus riser 126 could be formed having a frustum shape, where the primary stylus riser 126 would include a taper from a base end towards a smaller distal or free end. The primary stylus riser 126 extends outward from a primary stylus peripheral relief ring 124. The primary stylus peripheral relief ring 124 is supported by a primary stylus broad base section 120. The primary stylus broad base section 120 can include a primary stylus broad base tapered section 121. A primary stylus peripheral relief ridge 122 can optionally be included, wherein the primary stylus peripheral relief ridge 122 circumscribes the primary stylus peripheral relief ring 124. The primary stylus peripheral relief ridge 122 would be included to reinforce the flexure edge of the primary stylus peripheral relief ring 124. The primary stylus peripheral relief ring 124 would have a thickness enabling an omni-directional pivotal motion of the primary stylus riser 126. The primary stylus peripheral relief ring 124 additionally introduces an axial compliance to the primary stylus riser 126, enabling the primary stylus pressure applying contacting surface 128 to slightly move axially when pressure is applied thereto. The primary stylus peripheral relief ridge 122 can be formed having a rounded edge, a squared off edge, or any other suitable design. The primary stylus riser 126 transitions into a primary stylus pressure applying contacting surface 128 at a distal edge. The transitioning edge can be crisp (square) or preferably include a rounded or chamfered transition. The rounded or chamfered transition is provided for longevity of the pressure applicator apparatus 100 and comfort to the patient.

The primary stylus pressure applying contacting surface 128 should be of such a size where the primary stylus pressure applying contacting surface 128 will not penetrate the skin when the pressure applicator apparatus attachment strap assembly 200 is tightened to the optimum pressure but will transmit a concentrated force on the desired location on the patient. The primary stylus peripheral relief ring 124 and the primary stylus riser 126 serve to tighten the patient's skin around the stylus and flatten the underlying tissue to concentrate the pressure on the desired location on the patient. The skin and underlying tissue partially fills the primary stylus peripheral relief ring 124 to provide resistance to movement of the stylus either by muscular movement of the patient or external forces. It is understood that the primary stylus can be of any reasonable form factor for applying a pressure to the desired area.

In the exemplary illustration, the pressure applicator apparatus 100 includes a first pair of primary stylus linearly arranged along a perpendicular axis 190 and a second pair of primary stylus linearly arranged along a parallel axis 192, wherein the perpendicular axis 190 is arranged being perpendicular to an elongated axis of the pressure applicator apparatus attachment strap assembly 200 and the parallel axis 192 is arranged being parallel to the elongated axis of the pressure applicator apparatus attachment strap assembly 200.

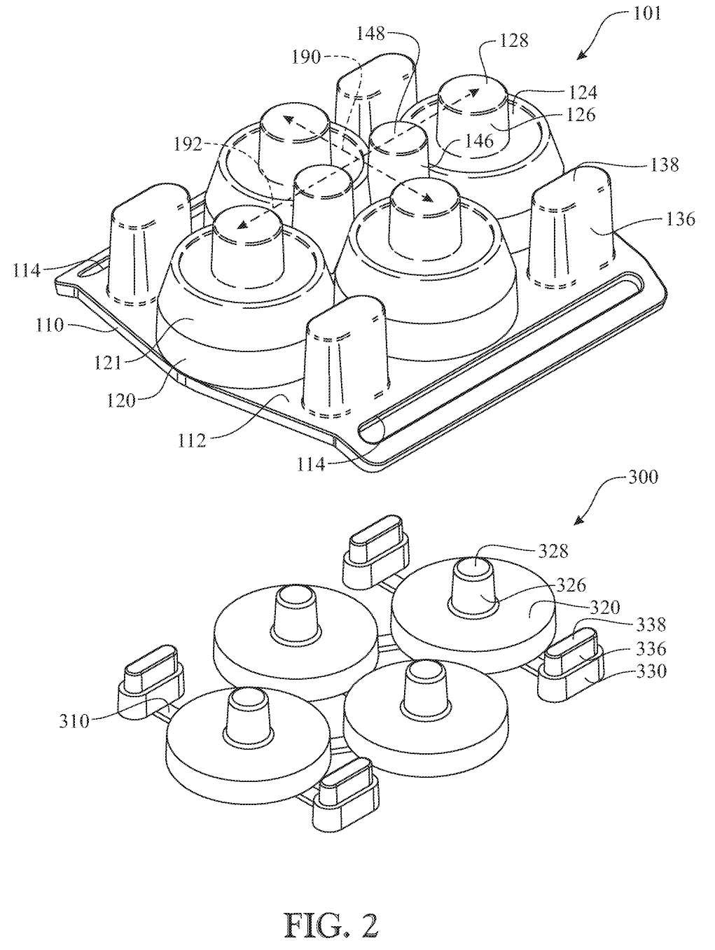

The pressure applicator apparatus 100 additionally includes a second or secondary set of styluses. The secondary stylus is detailed in the illustration shown in FIGS. 1 and 2. Each secondary stylus comprising a secondary elongated stylus riser 136 having a secondary elongated stylus pressure applying contacting surface 138 located at a distal free end thereof. The secondary elongated stylus riser 136 extends outward from the pressure applicator base member stylus supporting surface 112, wherein a central axis of the secondary elongated stylus riser 136 is preferably substantially perpendicular to a plane of the pressure applicator base member stylus supporting surface 112. The secondary elongated stylus pressure applying contacting surface 138 is preferably designed having an oblong or rounded rectangular shape. The secondary elongated stylus pressure applying contacting surface 138 is preferably planar, wherein the plane is substantially perpendicular to an elongated axis of the secondary elongated stylus riser 136.

Similar to the primary stylus, the secondary elongated stylus riser 136 transitions into a secondary elongated stylus pressure applying contacting surface 138 at a distal edge. The transitioning edge can be crisp (square) or preferably include a rounded or chamfered transition. The rounded or chamfered transition is provided for longevity of the pressure applicator apparatus 100 and comfort to the patient. Each secondary stylus is located at a corner outside of a respective pair of primary styluses.

The plurality of primary stylus pressure applying contacting surfaces 128 define a first plane. The plurality of secondary elongated stylus pressure applying contacting surfaces 138 define a second plane. The first plane and the second plane can be the same plane or two different planes (as shown). In the exemplary illustration, the second plane is closer to the pressure applicator base member stylus supporting surface 112 than the first plane. Each secondary elongated stylus pressure applying contacting surface 138 is located outboard of the primary stylus pressure applying contacting surface 128 along a direction of the parallel axis 192.

The pressure applicator apparatus 100 additionally includes a third or supplemental set of styluses. The supplemental stylus is detailed in the illustration shown in FIGS. 1 and 2. Each supplemental stylus comprising a supplemental elongated stylus riser 146 having a supplemental elongated stylus pressure applying contacting surface 148 located at a distal free end thereof. The supplemental elongated stylus riser 146 extends outward from the pressure applicator base member stylus supporting surface 112, wherein a central axis of the supplemental elongated stylus riser 146 is preferably substantially perpendicular to a plane of the pressure applicator base member stylus supporting surface 112. The supplemental elongated stylus pressure applying contacting surface 148 is preferably designed having a circular shape. The supplemental elongated stylus pressure applying contacting surface 148 is preferably planar, wherein the plane is substantially perpendicular to an elongated axis of the supplemental elongated stylus riser 146. Each of the supplemental styluses is arranged in linear arrangement with the portion of the primary styluses arranged parallel to the perpendicular axis 190. Although the supplemental styluses are shown having a circular shaped supplemental elongated stylus pressure applying contacting surface 148, it is understood that the supplemental elongated stylus pressure applying contacting surface 148 can be of any suitable shape. The supplemental elongated stylus riser 146 can be cylindrically shaped or frustum shaped.

The pressure applicator apparatus 100 can be fabricated of a single component or a plurality of components, as shown in FIG. 2. The single component version would preferably be fabricated of a pliant material such as silicone, rubber, and the like and would be designed to be sufficiently rigid to adequately apply the desired pressure level to accomplish the desired results. In a multi-component version, the pressure applicator apparatus 100 includes a pressure applicator shell member 101 and a pressure applicator core member 300. The pressure applicator shell member 101 would include cavities extending inward from an underside thereof to receive supporting features provided by the pressure applicator core member 300.

The pressure applicator core member 300 includes a series of first stylus supporting features, a series of second stylus supporting features, and a series of supplemental stylus supporting features. The series of first stylus supporting features are arranged having each first stylus supporting feature to be in registration with a respective cavity within a rear portion of the first stylus. The series of second stylus supporting features are arranged having each second stylus supporting feature to be in registration with a respective cavity within a rear portion of the second stylus. The series of supplemental styluses can remain unsupported as shown or include a stylus supporting feature, wherein the supplemental stylus supporting feature would be configured having features similar to those of the second stylus supporting feature.

The first or primary stylus supporting feature comprises a core member primary stylus support riser distal surface 328 spanning across a distal, free end of a core member primary stylus support riser 326, the core member primary stylus support riser 326 extending upward from a core member primary stylus support base 320. Each core member primary stylus support base 320 is supported by the core member frame 310. A central axis of the core member primary stylus support riser 326 extends substantially, perpendicularly upwards from an upper surface of the core member primary stylus support base 320. The core member primary stylus support riser 326 can be cylindrically shaped, frustum shaped (as shown), or of any other suitable shape. The components of each first stylus supporting feature are sized and shaped to be matingly inserted into each respective cavity (not shown) within the respective primary stylus. The core member primary stylus support riser 326 and the core member primary stylus support riser distal surface 328 can be sized and located enabling flexure of the first or primary stylus.

The second stylus supporting feature comprises a core member secondary stylus support riser distal surface 338 spanning across a distal, free end of a core member secondary stylus support riser 336, the core member secondary stylus support riser 336 extending upward from a core member secondary stylus support base 330. Each core member secondary stylus support base 330 is supported by the core member frame 310. A central axis of the core member secondary stylus support riser 336 extends substantially, perpendicularly upwards from an upper surface of the core member secondary stylus support base 330. The core member secondary stylus support riser 336 can be cylindrically shaped, frustum shaped (as shown), or of any other suitable shape. The components of each second stylus supporting feature are sized and shaped to be matingly inserted into each respective cavity (not shown) within the respective secondary stylus. The core member secondary stylus support riser 336 and the core member secondary stylus support riser distal surface 338 can be sized and located enabling flexure of the secondary stylus.

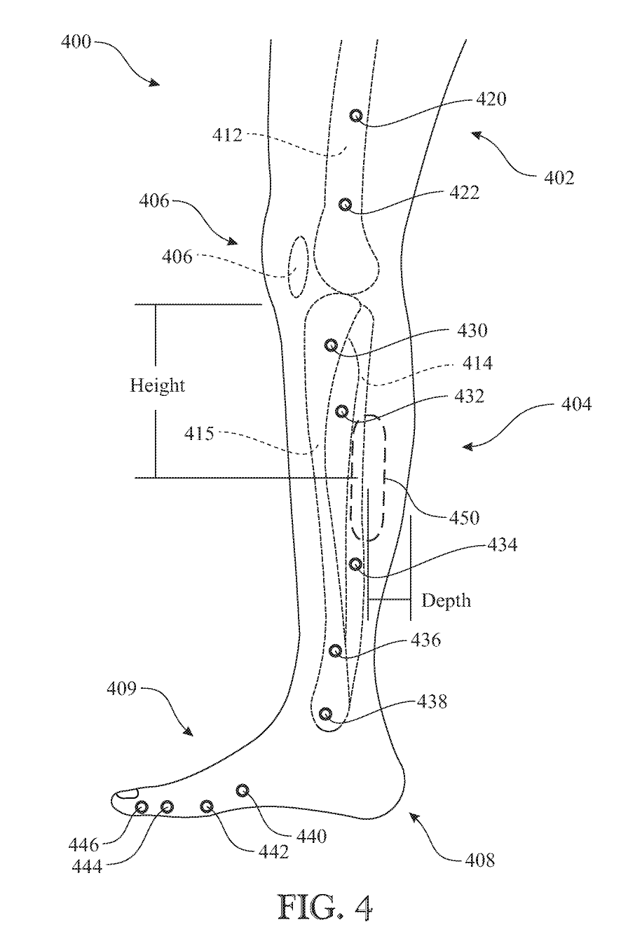

When using the pressure applicator apparatus 100, it is helpful to have anatomical knowledge of a patient's leg 400 of the patient, such as those anatomical features illustrated in FIG. 4. The patient's leg 400 includes a patient's upper leg 402 extending downward from a hip (not shown), a patient's lower leg 404 extending downward from the patient's upper leg 402, a patient's knee 406 provided between the patient's upper leg 402 and the patient's lower leg 404, a patient's calf 405 located at a rear portion of the patient's lower leg 404, a patient's foot 409 located at a distal, free end of the patient's lower leg 404, and a patient's ankle 408 located at a rear, base portion of the patient's foot 409. The patient's leg 400 is supported by structural elements or bones, including a patient's femur 412, supporting the patient's upper leg 402; a patient's fibula 414 and a patient's tibia 415 support the patient's lower leg 404, a patient's patella 416 protecting the patient's knee 406, among others that are not shown or referenced herein.

The patient's leg 400 includes a series of acupoints. The patient's upper leg 402 includes an acupoint SP 10 (Xuehal) 422 located on the inner thigh, slightly above the patient's knee 406 and an acupoint SP 11 (Jimen) 420 located on the inner thigh, approximately 6 can (inches) above the acupoint SP 10 (Xuehal) 422. The patient's lower leg 404 includes an acupoint SP 9 (Yinlingquan) 430 located on the inner portion of the patient's calf 405, slightly below the patient's knee 406; an acupoint SP 8 (Diji) 432 located on the inner portion of the patient's calf 405, approximately 3 inches below the acupoint SP 9 (Yinlingquan) 430, an acupoint SP 8 (Diji) 432 located on the inner calf, approximately 4 inches below the acupoint SP 8 (Diji) 432, an acupoint SP 7 (Lougu) 434 located on the inner portion of the patient's calf 405, approximately 4 inches below the acupoint SP 8 (Diji) 432, an acupoint SP 6 (Sanyinjiao) 436 located on the inner portion of the patient's calf 405, approximately 3 inches below the acupoint SP 7 (Lougu) 434, and an acupoint SP 5 (Shangqiu) 438 located proximate an ankle (not identified, but commonly known) of the patient, approximately 3 inches below the acupoint SP 6 (Sanyinjiao) 436. Additional acupoints are located on the patient's foot 409, including an acupoint SP 4 (Gongsun) 440 located on an interior region of the patient's foot 409; an acupoint SP 3 (Taibai) 442 located on an interior region of the patient's foot 409, forward of the acupoint SP 4 (Gongsun) 440; an acupoint SP 2 (Dadu) 444 located on an interior region of the patient's foot 409, forward of the acupoint SP 3 (Taibai) 442 and proximate a base of a patient's large toe (not identified, but commonly known); and an acupoint SP 1 (Yinbai) 446 located on an interior region of the patient's foot 409, forward of the acupoint SP 2 (Dadu) 444 and proximate a central region of a patient's large toe.

Although one means of applying pressure is by identifying a specific acupressure point, it was recognized by the inventor while continuing development of the product and process, that the acupressure point is not accurate. Although the acupressure point can provide some aid, it was identified that improved results were achieved by identifying a specific menstrual discomfort controlling pressure point 450, introduced in FIG. 4. The pressure applicator apparatus 100 would be employed to apply a pressure to the menstrual discomfort controlling pressure region 450 of the patient's calf 405. The menstrual discomfort controlling pressure region 450 is located between the acupoint SP 8 (Diji) 432 and the acupoint SP 7 (Lougu) 434. The menstrual discomfort controlling pressure point is located within a region on the calf 140 referred to as a menstrual discomfort controlling pressure region 150 as illustrated in FIG. 5. The menstrual discomfort controlling pressure region 450 is generally located on the inner region of the patient's lower leg 404 at a height of 3-4″ below the lower edge of the knee cap 416 and 1-2″ from the rear edge of the patient's lower leg 404 towards the inner region of the patient's lower leg 404. It has been identified that there are normally 2-3 tender spots in the menstrual discomfort controlling pressure region 450.

In use, the menstrual discomfort controlling pressure region 450 would be located by touching the general area assumed to be the menstrual discomfort controlling pressure region 450 until the actual menstrual discomfort controlling pressure region 450 is located. The pressure applicator apparatus 100 would be located being centered about the tender spot, as shown in FIG. 5. The pressure applicator apparatus 100 would be secured in position using the pressure applicator apparatus attachment strap assembly 200 as shown in FIG. 6. The distal end of the pressure applicator apparatus attachment strap assembly 200 would be inserted through the strap buckle aperture 222 of the strap buckle 220 and looped back in a reverse direction and subsequently secured to the pressure applicator apparatus attachment strap free end 212 of the pressure applicator apparatus attachment strap assembly 200 using the dense hook and look features provided thereon. It is understood that any securing configuration and components can be employed to retain the pressure applicator apparatus 100 against the menstrual discomfort controlling pressure region 450 in a manner to generate a pressure application force thereto. The level of pressure applied can be adjusted by adjusting the tightness of the pressure applicator apparatus attachment strap assembly 200. More specifically, the amount of compression or the level of applied pressure can be accurately controlled by adjusting a length of the pressure applicator apparatus attachment strap assembly 200. When the desired amount of pressure is generated by the pressure applicator apparatus attachment strap assembly 200, the dense hook and loop swatch on the free end of the pressure applicator apparatus attachment strap assembly 200 is brought into contact and engages with the dense hook and loop swatch on the outside surface of the pressure applicator apparatus attachment strap assembly 200 to fix the pressure applicator apparatus attachment strap assembly 200 in the desired position.

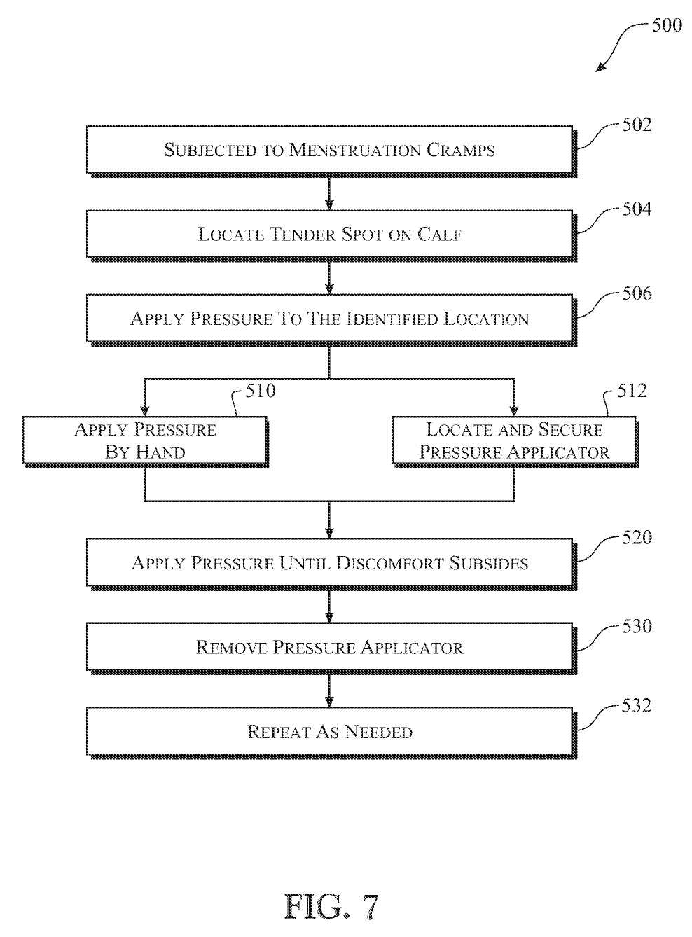

A menstruation cramps or discomfort alleviation flow diagram 500, presented in FIG. 7, describes steps for applying a pressure to the menstrual discomfort controlling pressure region 450 to relieve a patient of discomfort associated with a menstrual cycle of the patient.

The menstrual discomfort relief flow method 500 is initiated when a person recognizes they are being subjected to discomfort resulting from menstruation (step 502). The person feels about the menstrual discomfort controlling pressure region 450 to locate at least one tender spot (step 504) which identifies the menstrual discomfort controlling pressure region 450 on either calf 405. The user would apply light pressure about the menstrual discomfort controlling pressure region 450 to identify the at least one tender location. The at least one tender location identifies the at least one menstrual discomfort controlling pressure point. The user then applies pressure to each of these points. The two directional distribution of the primary, secondary, and supplemental styluses accommodates the varied locations of each of the tender points. This process of identifying the at least one menstrual discomfort controlling pressure point, optimizes the relief process. The inclusion of a plurality of styluses arranged in multiple directions optimizes the process by applying a distributed pressure about the general region, thus ensuring pressure is adequately applied to each of the tender spots. The person then applies a pressure to the tender area (step 506). The pressure can be applied by hand (step 510) or using the pressure applicating apparatus 100 (step 512). The application by hand is accomplished using the palm of the person applying the pressure and/or a plurality of fingers. The use of the palm and/or plurality of fingers spreads the applied pressure over a general area of the menstrual discomfort controlling pressure region 450, thus ensuring the pressure is applied in the correct area. Alternatively, one can use the pressure applicator apparatus 100 to apply the desired pressure to the tender area of the patient's calf 405. The configuration of the pressure applicator apparatus 100 applies the same distributed pressure about the menstrual discomfort controlling pressure region 450. One would tighten the pressure applicator apparatus attachment strap assembly 200 to a level that is tolerable (i.e. without causing pain) and secure the fasteners used to retain the pressure applicator apparatus attachment strap assembly 200 at a desired length. The cramps should begin to diminish and disappear.

More specifically, the series of primary stylus of the pressure applicator apparatus 100 are arranged in at least two different directions (wherein the primary styluses are distributed along both the perpendicular axis 190 and the parallel axis 192), spreading the applied pressure about the menstrual discomfort controlling pressure region 450. The pressure applicator apparatus 100 can additionally include a series of secondary pressure applying styluses. The series of secondary pressure applying styluses are located outward of the series of primary pressure applying styluses, further spreading the applied pressure over the menstrual discomfort controlling pressure region 450. The primary stylus pressure applying contacting surfaces 128 series of primary pressure applying styluses define a first plane. The secondary elongated stylus pressure applying contacting surface 138 of the series of secondary pressure applying styluses define a second plane. The first plane and the second plane can be provided along the same plane or different planes (as shown). When the first plane and the second plane are provided along different planes, the second plane is preferably lower or closer to the pressure applicator base member stylus supporting surface 112 than the first plane. The utilization of different planes applies varying pressure levels to the menstrual discomfort controlling pressure region 450. This increases the effectiveness, while also ensuring comfort to the patient. The inclusion of the series of supplemental styluses further distributes a pressure applied to the menstrual discomfort controlling pressure region 450. Since locating the tender spot can be difficult for certain persons, the configuration of the styluses about the pressure applicator apparatus 100 aids in ensuring pressure is adequately applied to the menstrual discomfort controlling pressure region 450. The pressure applicator apparatus 100 remains secured until the discomfort subsides (step 520). This is normally accomplished within 5 minutes. Once the discomfort subsides (step 520), the pressure applicator apparatus 100 would be removed from the patient's leg 400 (step 530). The process would be repeated as needed (step 532).

The pressure applicator apparatus 100 can include an instruction manual on how to properly use of the apparatus. The instruction manual can be provided in the form of a printed brochure, an audio tape, a floppy disk, a video disk (DVD), a link to an on-line instruction set, a universal serial bus (USB) memory device, and the like accompanying the pressure applicator apparatus 100 in a form of a kit. The patient can be instructed in the theory of acupressure, the anatomical location of the particular acupoints that relates to the malady to be treated is shown in illustrations or video, a method of teaching the patient on how to identify the location of the menstrual discomfort controlling pressure region 450, as well as, the correct amount of force to be used and the time frame of treatment.

Although the above is directed towards an apparatus and a method of using the apparatus for alleviating discomfort associated with menstrual cycles, the apparatus can be used to apply a pressure in other regions of the patient for treatment of other ailments. In one exemplary embodiment, the pressure applicator apparatus 100 can be employed to relieve discomfort from Endometriosis.

Endometriosis is an often painful disorder in which tissue that normally lines the inside of your uterus (the endometrium) grows outside your uterus (endometrial implant). Endometriosis most commonly involves a patient's ovaries, bowel or the tissue lining their pelvis. Rarely, endometrial tissue may spread beyond the patient's pelvic region.

In endometriosis, displaced endometrial tissue continues to act as it normally would; the endometrial tissue thickens, breaks down and bleeds with each menstrual cycle. Because the displaced endometrial tissue has no way to exit the patient's body, the displaced endometrial tissue becomes trapped. When endometriosis involves the ovaries, cysts called endometriomas may form. Surrounding tissue can become irritated, eventually developing scar tissue and adhesions, or abnormal tissue that binds organs together.

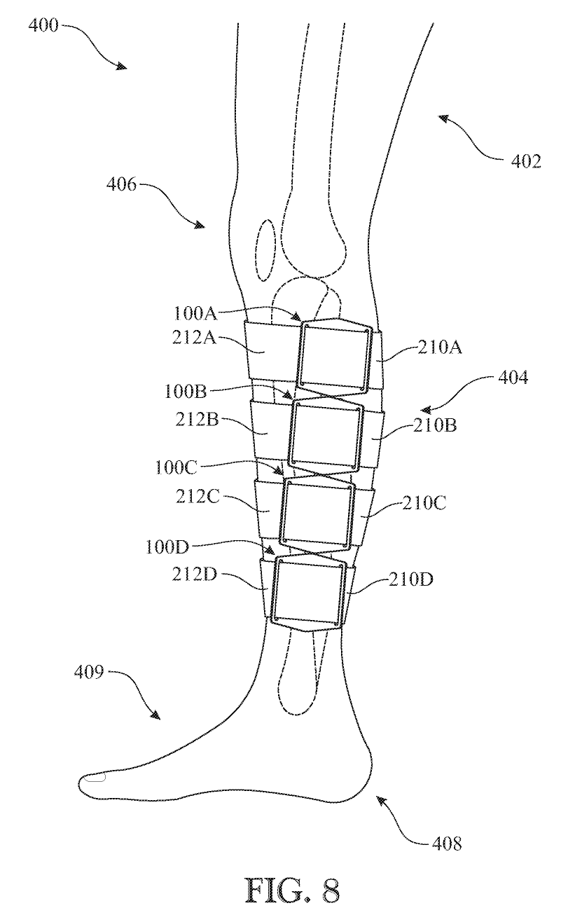

The pressure applicator apparatus 100, or a variant thereof, can be applied to the patient's leg 400, extending between the acupoint SP 9 (Yinlingquan) 430 and the acupoint SP 6 (Sanyinjiao) 436. In one solution, a series of pressure applicator apparatuses 100 are employed to apply a pressure in a generally linear arrangement extending between the acupoint SP 9 (Yinlingquan) 430 and the acupoint SP 6 (Sanyinjiao) 436. Each pressure applicator apparatus 100 is approximately 3″ in a direction parallel to the perpendicular axis 190. Four of the pressure applicator apparatuses 100A, 10B, 100C, 100D would apply pressure along a total span of approximately 12-13 inches, as shown in FIG. 8. Each pressure applicator apparatus 100A, 10B, 100C, 100D is secured by a respective pressure applicator apparatus attachment strap assembly 200, identified as a pressure applicator apparatus attachment first strap coupling end 210A, 210B, 210C, 210D and a pressure applicator apparatus attachment first strap free end 212A, 212B, 212C, 212D, respectively.

In a second solution, the pressure applicator apparatus 100 would be modified to be any division of 12 inches (or approximately thereof). For example, in one variant, the pressure applicator apparatus 100 would be designed having a dimension in a direction parallel to the perpendicular axis 190 of 6 inches. In a second variant, a modified pressure applicator apparatus 100 would be designed having a dimension in a direction parallel to the perpendicular axis 190 of 12 inches. The number of primary styluses would be such to provide pressure along the associated length in the direction parallel to the perpendicular axis 190. Additionally, the modified pressure applicator apparatus 100 would include a number of secondary styluses such to also provide pressure along the associated length in the direction parallel to the perpendicular axis 190. The modified pressure applicator apparatus 100 could also include a sufficient number of supplemental styluses as needed.

The pressure applicator apparatus 100, 101 is preferably fabricated of a pliant material, such as rubber, silicone, and the like. Alternative materials can be considered, such as plastics, wood, metal, bone, a composite material, and the like based upon the application and desired compliance of the material. It is also understood that at least a portion of the stylus riser and the associated stylus pressure applying contacting surface can be fabricated of a pliant material, such as silicone, rubber, and the like.

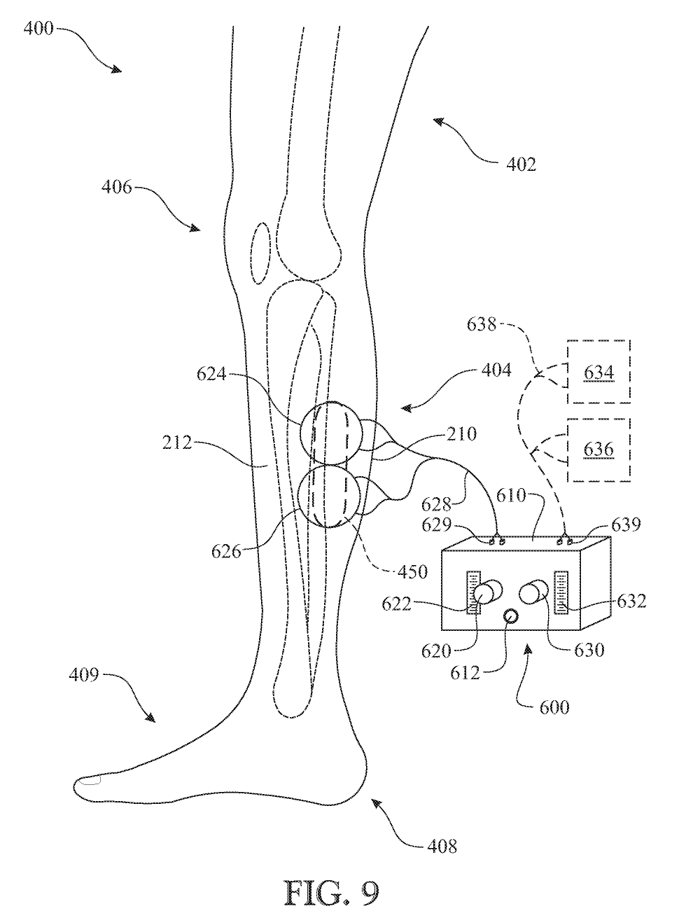

The above applications employ a pressure applicator apparatus 100, 101. In an alternative application, the same effects can be achieved by sending stimulating pulses across a surface of the skin and along nerve strands. The stimulating pulses help prevent pain signals from reaching the brain. In the exemplary application, a Transcutaneous Electrical Nerve Stimulation (TENS) system 600, introduced in FIG. 9 is employed to send stimulating pulses across the surface of the skin and along nerve strands. Tens devices also help stimulate your body to produce higher levels of its own natural painkillers, called “Endorphins”.

The Transcutaneous Electrical Nerve Stimulation (TENS) system 600 includes a TENS system controller 610 having at least one controller circuit. The TENS system controller 610 can include a TENS system controller power switch 612 to control overall operation of the entire system. Each controller circuit includes a TENS modulation controller 620, 630. The exemplary TENS system controller 610 includes a pair of controller circuits and respective modulation applicators. A first exemplary modulation application system is preceded by the numeral “62”. A second exemplary modulation application system is preceded by the numeral “63”. The TENS modulation controller 620, 630 can employ an analog modulation controlling device or a digital modulation controlling circuit. An output indicating the settings of the modulation can be provided by a TENS modulation indicator 622, 632. The TENS modulation indicator 622, 632 can be in a digital format, a linear gauge format, a dial gauge format, a series of illuminating devices (such as Light Emitting Diodes (LEDs)), or any other suitable format. Output from each TENS modulation controller 620, 630 is provided to one or a pair of electrodes 624, 626, 634, 636 by way of a TENS modulation wire lead 628, 638. Each TENS modulation wire lead 628, 638 is connected to the TENS system controller 610 by a TENS modulation wire lead terminal 629, 639. Each TENS modulation wire lead terminal 629, 639 includes a pair of wires; each wire is connected to the controller circuit by an independent electromechanical junction. Operation of the TENS system controller 610 is well known and would be based upon the configuration of the selected unit.

The electrodes 624, 626, 634, 636 can be provided in any suitable shape, including a round shape (as shown by the electrodes 624, 626), an oval shape, an elliptical shape, a square shape (as shown by the electrodes 634, 636), a rectangular shape, a triangular shape, a quadrilateral shape, a pentagonal shape, a hexagonal shape, an octagonal shape, a freeform shape, a star shape, and the like.

One or more electrodes 624, 626, 634, 636 would be placed onto the patient's leg covering the menstrual discomfort controlling pressure region 450. The electrodes 624, 626, 634, 636 provide stimulation across a region, as opposed to a single location. The use of multiple electrodes 624, 626, 634, 636 distributes the stimulation over a greater area.

In use, the user would adjust the respective TENS modulation controller 620, 630 to optimize an amplitude modulation. The TENS system controller 610 can additionally include other options for use, including interferential (4-pole), premodulated (2-pole interferential), medium frequency (Russian), EMS and TENS waveform. The user can choose between several different amplitude modulation options. The interferential and premodulated modes offer frequency modulation as well as a static frequency option.

The patient would locate the menstrual discomfort controlling pressure region 450 on their patient's leg 400. One or more electrodes 624, 626, 634, 636 are adhered to a portion of the patient's leg 400 covering the menstrual discomfort controlling pressure region 450. The patient or operator would adjust the respective TENS modulation controller 620, 630 to obtain a desired output. The Transcutaneous Electrical Nerve Stimulation (TENS) system 600 would apply the stimulation across a region over a period of time until the patient feels relief from the cramping. This commonly occurs in 5-10 minutes.

Although the above example is directed towards a method for relieving symptoms associated with menstruation, the same concept can be applied to addressing symptoms of endometriosis. The electrodes 624, 626, 634, 636 would be located along the same region where the 100A, 100B, 100C, 100D are located in FIG. 8.

To summarize the present invention, an application of pressure or stimulating pulses across the surface of the skin and along nerve strands to alleviate the symptoms associated with menstruation and/or endometriosis. The processes described herein can be repeated as needed.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

### ELEMENT DESCRIPTION REFERENCES

### Ref No. Description

100 pressure applicator apparatus
100A pressure applicator apparatus A
100B pressure applicator apparatus B
100C pressure applicator apparatus C
100D pressure applicator apparatus D
101 pressure applicator shell member
110 pressure applicator base member
112 pressure applicator base member stylus supporting surface
114 strap receiving slot
120 primary stylus broad base section
121 primary stylus broad base tapered section
122 primary stylus peripheral relief ridge
124 primary stylus peripheral relief ring
126 primary stylus riser
128 primary stylus pressure applying contacting surface
136 secondary elongated stylus riser
138 secondary elongated stylus pressure applying contacting surface
146 supplemental elongated stylus riser
148 supplemental elongated stylus pressure applying contacting surface
190 perpendicular axis
192 parallel axis
200 pressure applicator apparatus attachment strap assembly
210 pressure applicator apparatus attachment strap coupling end
210A pressure applicator apparatus attachment first strap coupling end A
210B pressure applicator apparatus attachment second strap coupling end B
210C pressure applicator apparatus attachment third strap coupling end C
210D pressure applicator apparatus attachment fourth strap coupling end D
212 pressure applicator apparatus attachment strap free end
212A pressure applicator apparatus attachment first strap free end A
212B pressure applicator apparatus attachment second strap free end B
212C pressure applicator apparatus attachment third strap free end C
212D pressure applicator apparatus attachment fourth strap free end D
214 strap buckle assembly loop
216 strap buckle assembly loop seam
220 strap buckle
222 strap buckle aperture
300 pressure applicator core member
310 core member frame
320 core member primary stylus support base
326 core member primary stylus support riser
328 core member primary stylus support riser distal surface
330 core member secondary stylus support base
336 core member secondary stylus support riser
338 core member secondary stylus support riser distal surface
400 patient's leg
402 patient's upper leg
404 patient's lower leg
405 patient's calf
406 patient's knee
408 patient's ankle
409 patient's foot
412 patient's femur
414 patient's fibula
415 patient's tibia
416 patient's patella
420 acupoint SP (Jimen)
422 acupoint SP (Xuehal)
430 acupoint SP (Yinlingquan)
432 acupoint SP (Diji)
434 acupoint SP (Lougu)
436 acupoint SP (Sanyinjiao)
438 acupoint SP (Shangqiu)
440 acupoint SP (Gong sun)
442 acupoint SP (Taibai)
444 acupoint SP (Dadu)
446 acupoint SP (Yinbai)
450 menstrual discomfort controlling pressure region
500 menstruation cramps or discomfort alleviation flow diagram
502 patient is subjected to menstruation cramps or discomfort step
504 locate tender region on patient's calf step
506 apply pressure to identified tender region on patient's calf step
510 apply pressure to identified tender region by hand step
512 apply pressure to identified tender region using pressure applicator step
520 continue applying pressure until discomfort subsides
530 remove pressure applicator from patient's calf step
532 repeat process as needed step
600 Transcutaneous Electrical Nerve Stimulation (TENS) system
610 TENS system controller
612 TENS system controller power switch
620 TENS first modulation controller
622 TENS first modulation indicator
624 TENS first output, first electrode
626 TENS first output, second electrode
628 TENS first modulation wire lead
629 TENS first modulation wire lead terminal
630 TENS second modulation controller
632 TENS second modulation indicator
634 TENS second output, first electrode
636 “TENS second output, second electrode
638 TENS second modulation wire lead
639 TENS second modulation wire lead terminal

What is claim is:

1. A discomfort relieving pressure applicator assembly comprising:
a pressure applicating apparatus supported by an attachment strap, wherein the attachment strap is sized and shaped to be tightly secured about a limb of a patient;
the pressure applicating apparatus comprising:
a base member defining a pressure applicator base member stylus supporting surface;
a set of primary styluses, each primary stylus comprising a primary stylus pressure application surface located at a free end of a primary stylus riser, each primary stylus riser having a central riser axis extending substantially perpendicular from the pressure applicator base member stylus supporting surface,
wherein a first portion of the set of primary styluses are linearly and spatially arranged in a direction parallel to an elongated axis of the attachment strap, and
wherein a second portion of the set of primary styluses are linearly and spatially arranged in a direction perpendicular to an elongated axis of the attachment strap,
wherein the pressure applicating apparatus is oriented projecting the set of primary styluses inward when the attachment strap is formed into a loop.

2. A discomfort relieving pressure applicator assembly as recited in claim 1, wherein the pressure applicating apparatus is fabricated of a tough elastic polymeric substance.

3. A discomfort relieving pressure applicator assembly as recited in claim 1, the attachment strap further comprising a dense hook and loop tape, the dense hook and loop tape providing adjustability of a circumference of the attachment strap when the attachment strap is formed into the loop.

4. A discomfort relieving pressure applicator assembly as recited in claim 1, the pressure applicating apparatus further comprising a set of supplemental styluses, each supplemental stylus comprising a supplemental elongated stylus pressure applying contacting surface located at a free end of a supplemental stylus riser, each supplemental stylus riser having a central riser axis extending substantially perpendicular from the pressure applicator base member stylus supporting surface.

5. A discomfort relieving pressure applicator assembly as recited in claim 4, each supplemental elongated stylus pressure applying contacting surface having at least one of a size and a shape that differs from a like at least one of size and the shape of the primary stylus pressure application surface.

6. A discomfort relieving pressure applicator assembly as recited in claim 1, the pressure applicating apparatus further comprising a set of supplemental styluses, each supplemental stylus comprising a supplemental elongated stylus pressure applying contacting surface located at a free end of a supplemental stylus riser, each supplemental stylus riser having a central riser axis extending substantially perpendicular from the pressure applicator base member stylus supporting surface, each supplemental stylus being linearly and spatially arranged with the second portion of the set of primary styluses.

7. A discomfort relieving pressure applicator assembly comprising:
a pressure applicating apparatus supported by an attachment strap, wherein the attachment strap is sized and shaped to be tightly secured about a limb of a patient;
the pressure applicating apparatus comprising:
a base member defining a pressure applicator base member stylus supporting surface;
a set of primary styluses, each primary stylus comprising a primary stylus pressure application surface located at a free end of a primary stylus riser, each primary stylus riser having a central riser axis extending substantially perpendicular from the pressure applicator base member stylus supporting surface,
wherein a first portion of the set of primary styluses are linearly and spatially arranged in a direction parallel to an elongated axis of the attachment strap,
wherein the primary stylus pressure application surfaces of the primary styluses of the set of primary styluses are substantially coplanar, and
wherein a second portion of the set of primary styluses are linearly and spatially arranged in a direction perpendicular to an elongated axis of the attachment strap,
wherein the pressure applicating apparatus is oriented projecting the set of primary styluses inward when the attachment strap is formed into a loop.

8. A discomfort relieving pressure applicator assembly as recited in claim 7, wherein the pressure applicating apparatus is fabricated of a tough elastic polymeric substance.

9. A discomfort relieving pressure applicator assembly as recited in claim 7, the attachment strap further comprising a dense hook and loop tape, the dense hook and loop tape providing adjustability of a circumference of the attachment strap when the attachment strap is formed into the loop.

10. A discomfort relieving pressure applicator assembly as recited in claim 7, the pressure applicating apparatus further comprising a set of supplemental styluses, each supplemental stylus comprising a supplemental elongated stylus pressure applying contacting surface located at a free end of a supplemental stylus riser, each supplemental stylus riser having a central riser axis extending substantially perpendicular from the pressure applicator base member stylus supporting surface.

11. A discomfort relieving pressure applicator assembly as recited in claim 10, each supplemental elongated stylus pressure applying contacting surface having at least one of a size and a shape that differs from a like at least one of size and the shape of the primary stylus pressure application surface.

12. A discomfort relieving pressure applicator assembly as recited in claim 7, the pressure applicating apparatus further comprising a set of supplemental styluses, each supplemental stylus comprising a supplemental elongated stylus pressure applying contacting surface located at a free end of a supplemental stylus riser, each supplemental stylus riser having a central riser axis extending substantially perpendicular from the pressure applicator base member stylus supporting surface,
wherein each of the supplemental elongated stylus pressure applying contacting surfaces are substantially coplanar with the plane defined by the primary stylus pressure application surfaces.

13. A discomfort relieving pressure applicator assembly as recited in claim 7, the pressure applicating apparatus further comprising a set of supplemental styluses, each supplemental stylus comprising a supplemental elongated stylus pressure applying contacting surface located at a free end of a supplemental stylus riser, each supplemental stylus riser having a central riser axis extending substantially perpendicular from the pressure applicator base member stylus supporting surface,
wherein each of the supplemental elongated stylus pressure applying contacting surfaces are substantially distal from the plane defined by the primary stylus pressure application surfaces.

14. A discomfort relieving pressure applicator assembly as recited in claim 7, the pressure applicating apparatus further comprising a set of supplemental styluses, each supplemental stylus comprising a supplemental elongated stylus pressure applying contacting surface located at a free end of a supplemental stylus riser, each supplemental stylus riser having a central riser axis extending substantially perpendicular from the pressure applicator base member stylus supporting surface, each supplemental stylus being linearly and spatially arranged with the second portion of the set of primary styluses.

15. A discomfort relieving pressure applicator assembly comprising:
a pressure applicating apparatus supported by an attachment strap, wherein the attachment strap is sized and shaped to be tightly secured about a limb of a patient;
the pressure applicating apparatus comprising:
a base member defining a pressure applicator base member stylus supporting surface;
a set of primary styluses, each primary stylus comprising a primary stylus pressure application surface located at a free end of a primary stylus riser, each primary stylus riser having a central riser axis extending substantially perpendicular from the pressure applicator base member stylus supporting surface,
wherein a first portion of the set of primary styluses are linearly and spatially arranged in a direction parallel to an elongated axis of the attachment strap, and
wherein a second portion of the set of primary styluses are linearly and spatially arranged in a direction perpendicular to an elongated axis of the attachment strap,
wherein the pressure applicating apparatus is oriented projecting the set of primary styluses inward when the attachment strap is formed into a loop,
wherein the first portion of the set of primary styluses are positioned generally vertically against an interior portion of a patient's calf along a menstrual discomfort controlling pressure region,
wherein the second portion of the set of primary styluses are positioned generally laterally against an interior portion of a patient's calf proximate the menstrual discomfort controlling pressure region,
wherein the menstrual discomfort controlling pressure region is identified by a series of tender spots defining a tender region, the menstrual discomfort controlling pressure region being located at a height of between 3 and 4 inches below a lower edge of a knee cap and between 1 and 2 inches inward from a rear edge of a patient's lower leg.

16. A discomfort relieving pressure applicator assembly as recited in claim 15, wherein the pressure applicating apparatus is fabricated of a tough elastic polymeric substance.

17. A discomfort relieving pressure applicator assembly as recited in claim 15, the attachment strap further comprising a dense hook and loop tape, the dense hook and loop tape providing adjustability of a circumference of the attachment strap when the attachment strap is formed into the loop.

18. A discomfort relieving pressure applicator assembly as recited in claim 15, the pressure applicating apparatus further comprising a set of supplemental styluses, each supplemental stylus comprising a supplemental elongated stylus pressure applying contacting surface located at a free end of a supplemental stylus riser, each supplemental stylus riser having a central riser axis extending substantially perpendicular from the pressure applicator base member stylus supporting surface.

19. A discomfort relieving pressure applicator assembly as recited in claim 18, each supplemental elongated stylus pressure applying contacting surface having at least one of a size and a shape that differs from a like at least one of size and the shape of the primary stylus pressure application surface.

20. A discomfort relieving pressure applicator assembly as recited in claim 15, the pressure applicating apparatus further comprising a set of supplemental styluses, each supplemental stylus comprising a supplemental elongated stylus pressure applying contacting surface located at a free end of a supplemental stylus riser, each supplemental stylus riser having a central riser axis extending substantially perpendicular from the pressure applicator base member stylus supporting surface, each supplemental stylus being linearly and spatially arranged with the second portion of the set of primary styluses.
